(19) United States
(12) Patent Application Publication
(10) Pub. No.: US 2007/0030685 A1
(43) Pub. Date: Feb. 8, 2007

(54) Color-changing ornamental objects

(76) Inventor: Ta L. Wang, Taipei Hsien (TW)

Correspondence Address: GIFFORD, KRASS, GROH, SPRINKLE & CITKOWSKI, P.C, PO BOX 7021, TROY, MI, 48007-7021, US

(21) Appl. No.: 11/500,094

(22) Filed: Aug. 7, 2006

Related U.S. Application Data
(60) Provisional application No. 60/706,168, filed on Aug. 5, 2005.

(51) Int. Cl. F21S 13/10

(52) U.S. Cl. 362/363

(57) ABSTRACT

An ornamental object comprises a hollow form having at least some transparent or semi-transparent wall sections, and a lighting assembly disposed in the form, the assembly including one or more lights that cycle through different colors to create a decorative effect. In the preferred embodiment the lights are LEDs and the form is a sphere. A support may be provided upon which the form is placed.

### REFERENCE TO RELATED APPLICATION

This application claims priority to U.S. provisional Patent Application Ser. No. 60/706,168, filed Aug. 5, 2005, the entire content of which is incorporated herein by reference.

### FIELD OF THE INVENTION

This invention relates generally to ornamental objects such as gazing globes, and the like, and, in particular, to such objects including color-changing illumination.

### BACKGROUND OF THE INVENTION

So-called “gazing globes” are spherical objects, usually made out of a hollow glass form, which are placed on pedestals and other stands for use in gardens and other indoor/outdoor environments. Such articles have become increasingly popular as a way to decorate different environments and surroundings.

Although existing gazing globes may have reflective surfaces or interesting color patterns, they are passive in the sense that they do nothing more and are limited in terms of their decorative effect.

### SUMMARY OF THE INVENTION

This invention resides in an ornamental object comprising a hollow form having at least some transparent or semi-transparent wall sections, and a lighting assembly disposed in the form, the assembly including one or more lights that cycle through different colors to create a decorative effect. In the preferred embodiment the lights are LEDs and the form is a sphere. A support may be provided upon which the form is placed.

### BRIEF DESCRIPTION OF THE DRAWINGS

FIG. 1 is a drawing of the preferred embodiment of the invention;

FIG. 2 shows a support removed from an opening in a globe;

FIG. 3 shows a lighting assembly being removed from the support;

FIG. 4 is a more detailed view of the light assembly, which includes electronics to drive emitters, preferably light-emitting diodes; and

FIG. 5 shows a globe according to the invention supported upon one of many possible stands.

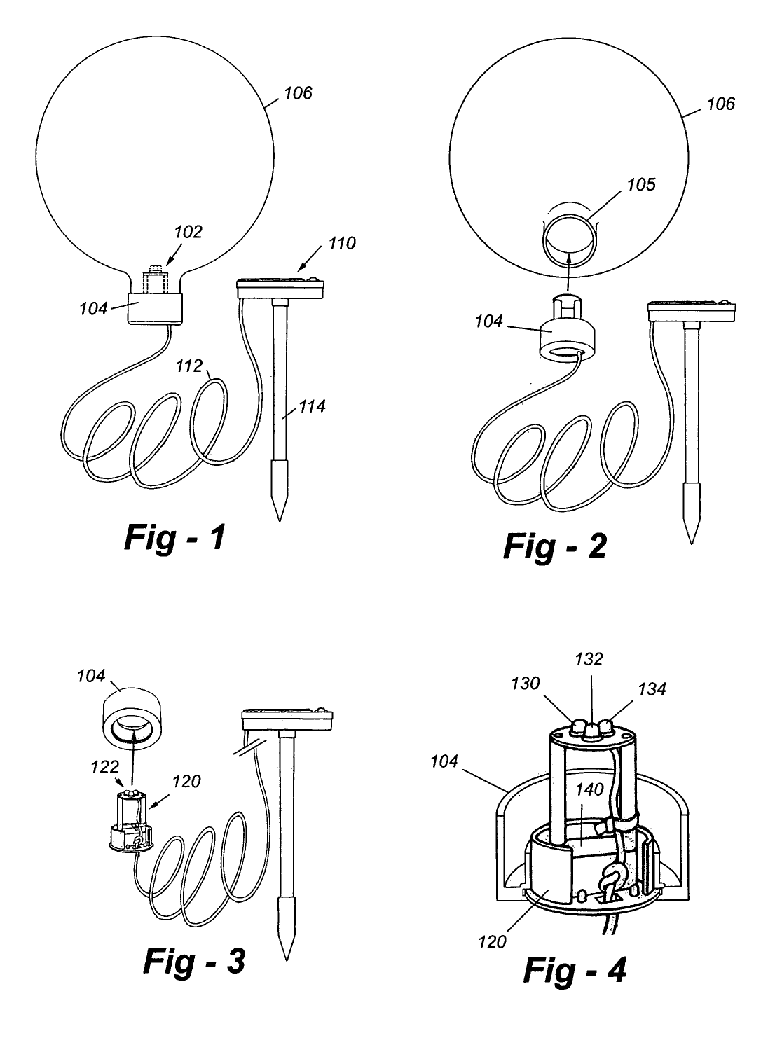

### DETAILED DESCRIPTION OF THE INVENTION

This invention improves upon gazing globes, and the like, through the addition of a color-changing mechanism, preferably solar powered to eliminate the need for an electrical hookup or battery change.

Reference is now made to the drawings, which show a hollow globe 106, including an opening 105 into which there is installed a support 104 including a light assembly 102. The light assembly 102 is connected to a source of power through wiring 112. In the preferred embodiment, the source of power is a solar panel assembly 110 which may include a stake 114 for in-ground installation. As an alternative to a photovoltaic power supply, batteries or a power converter for AC use may be provided.

Although this invention is being described with respect to a spherical hollow form, it may be appreciated that the system and method are applicable to any type of form, including non-spherical objects. Such objects may include animal shapes, birdbaths, pumpkins, snowmen, etc. Although such objects are preferably made from glass, plastic may also be used, and transparent and semitransparent wall structures may be included. That is, the invention is not limited in terms of the shape or color or design of the object, so long as some light is able to escape in some places.

FIG. 2 shows the support 102 removed from an opening in globe 106, and FIG. 3 shows the lighting assembly 120 being removed from the support 104. This, in turn, shows a pedestal onto which a light assembly is mounted.

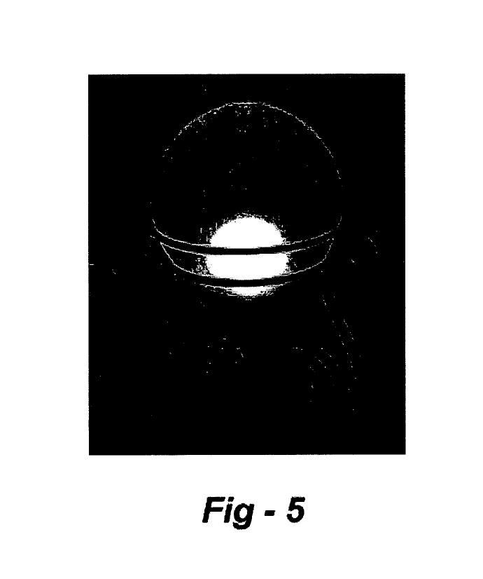

FIG. 4 is yet a more detailed view of the light assembly 120, which includes electronics 140 to drive emitters 130, 132, 134, preferably light-emitting diodes. Although any number of light emitters may be used, three are used in the preferred embodiment to produce a wide range of primary and secondary colors. Although the LEDs are generally provided in individual packages, single components with multiple emitters may also be used. FIG. 5 shows a globe according to the invention supported upon one of many possible stands.

The electronics contained in unit 140 may be programmed to drive the emitters in any timing sequence, such as a cycling through the rainbow, using red, green and blue LEDs, which transition from pure red to reddish green, to green, to greenish blue, to violet, and so forth. An entire cycle can take any time, but preferably on the order of a few seconds to a minute, or thereabouts. Yellow emitters and violet emitters may alternatively be used, depending upon the technology available at the time. The circuitry in unit 140 responsible for the cycling of the LEDs will be well known and appreciated to anyone of skill in electronic circuit design. For example, the circuits disclosed in U.S. Pat. Nos. 6,819,056 and 6,616,292 may be applicable, and those disclosures are incorporated herein by reference in their entireties.

In addition to the circuitry provided to cycle the LEDs, the preferred embodiment further includes a photocell used to activate the system at dusk and deactivate the system at dawn to save on battery power. The battery is preferably located in the photovoltaic device 110, though the battery may be located in the housing 120, and/or the circuitry in housing 120 may be located in the photovoltaic portion 110. Placement of the electronics is immaterial, so long as the system operates as described herein.

I claim:

1. An ornamental object, comprising:
a hollow form having at least some transparent or semi-transparent wall sections; and
a lighting assembly disposed in the form, the assembly including one or more lights that cycle through different colors to create a decorative effect.

2. The ornamental object of claim 1, wherein the lights are LEDs.

3. The ornamental object of claim 1, wherein the form is a sphere.

4. The ornamental object of claim 1, further including a support upon which the form is placed.

5. An ornamental object, comprising:
a hollow, transparent or translucent sphere; and
a lighting assembly disposed in the sphere, the assembly including one or more lights that cycle through different colors to create a decorative effect.

6. The ornamental object of claim 5, wherein the lights are LEDs.

7. The ornamental object of claim 5, further including a support upon which the sphere is placed.
